(19) United States
(12) Patent Application Publication
(10) Pub. No.: US 2010/0145602 A1
(43) Pub. Date: Jun. 10, 2010

(54) Methods, Systems, And Computer Program Products For Associating Resources Of A First Geospace With A Second Geospace

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/328,038

(22) Filed: Dec. 4, 2008

(51) Int. Cl. G01C 21/00

(52) U.S. Cl. 701/200

(57) ABSTRACT

Associating resources of a first geospace with a second geospace is described. In one aspect, a first representation of a resource is presented at a first location in a first map associated with a first address space. The first location has a first address in the first address space. A request is received to present a second representation of the resource in a second map associated with a second address space. The first address is translated to a second address in the second address space based on a relationship associating the first address space with the second address space. The translation includes establishing an association between the second address and the network identifier based on an association between the first address and the network identifier. The second representation of the resource is presented in the second map at a second location having the second address.

### RELATED APPLICATIONS

This application is related to the following commonly owned U.S. Patent Applications, the entire disclosure of each being incorporated by reference herein:

Application Ser. No. 11/962,285 (Attorney Docket No 1509/US) filed on Dec. 21, 2007, entitled “Methods and Systems for Sending Information to a Zone Included In an Internet Network”;

Application Ser. No. ______ (Attorney Docket No I516/US) filed on ______, entitled “Methods, Systems, and Computer Program Products for Accessing a Resource Based on Metadata Associated with a Location on a Map”;

Application Ser. No. 12/170,281 (Attorney Docket No I522/US) filed on ______, entitled “Methods and Systems for Resolving a Geospatial Query Region to a Network Identifier”;

Application Ser. No. 12/170,829 (Attorney Docket No I523/US) filed on ______, entitled “Methods and Systems for Resolving Location Information to a Network Identifier”;

Application Ser. No. 12/170,833 (Attorney Docket No I524/US) filed on ______, entitled “Methods and Systems for Resolving a Query Region to a Network Identifier”;

Application Ser. No. ______ (Attorney Docket No I527/US) filed on ______, entitled “Methods, Systems, and Computer Program Products for Determining a Network Identifier of a Node Providing a Type of Service for a Geospatial Region”;

Application Ser. No. ______ (Attorney Docket No I496/US) filed on ______, entitled “Methods, Systems, and Computer Program Products for Browsing Using a Geospatial Map Metaphor”;

Application Ser. No. _____ (Attorney Docket No I515/US) filed on ______, entitled “Methods, Systems, and Computer Program Products for Resolving a Network Identifier Based on a Geospatial Domain Space Harmonized with a Non-Geospatial Domain Space”; and

Application Ser. No. ______ (Attorney Docket No I534/US) filed on ______, entitled “Methods, Systems, and Computer Program Products for Accessing a Resource Having a Network Address Associated with a Location on a Map.”

### BACKGROUND

Current mapping applications display resources in association with their locations on a map of a region of a particular geospace, which is usually a portion of the earth. However, the distribution of resources over a particular geospace is not always suited to easy location and/or identification of a resource by a user. For example, in an area with dense resource associations, the presentation of resources can interfere with one another. In another example, two resources a user accesses often can have a great distance between them, requiring a user to perform more navigation than is desired.

### SUMMARY

Methods and systems are described for associating resources of a first geospace with a second geospace. In one aspect, a first representation of a resource is presented at a first location in a first map associated with a first address space. The first location has a first address in the first address space. An association between the first address space and a network identifier space includes an association between the first address and a network identifier for accessing the resource. A request is received to present a second representation of the resource in a second map associated with a second address space. The first address is translated to a second address in the second address space based on a relationship associating the first address space with the second address space. The translation includes establishing an association between the second address and the network identifier based on the association between the first address and the network identifier. The second representation of the resource is presented in the second map at a second location having the second address.

In another aspect, a system for associating resources of a first geospace with a second geospace includes means for presenting a first representation of a resource at a first location in a first map associated with a first address space. The first location has a first address in the first address space and an association between the first address space and a network identifier space includes an association between the first address and a network identifier for accessing the resource. The system also includes means for receiving a request to present a second representation of the resource in a second map associated with a second address space. The system also includes means for translating the first address in the first address space to a second address in the second address space based on a relationship associating the first address space with the second address space. The translation of the first address to the second address includes establishing an association between the second address and the network identifier based on the association between the first address and the network identifier. The system also includes means for presenting the second representation of the resource in the second map at a second location having the second address.

In another aspect, a system for associating resources of a first geospace with a second geospace includes a first map widget handler component configured to present a first representation of a resource at a first location in a first map associated with a first address space. The first location has a first address in the first address space and an association between the first address space and a network identifier space includes an association between the first address and a network identifier for accessing the resource. The system also includes a presentation controller component configured to receive a request to present a second representation of the resource in a second map associated with a second address space. The system also includes a navigation space handler component configured to translate the first address in the first address space to a second address in the second address space based on a relationship associating the first address space with the second address space The translating the first address to the second address includes establishing an association between the second address and the network identifier based on the association between the first address and the network identifier. The system also includes a second map widget handler component configured to present the second representation of the resource in the second map at a second location having the second address.

Claim 1 defines a computer readable medium embodying a computer program, executable by a machine, for associating resources of a first geospace with a second geospace. The computer program includes executable instructions for: presenting a first representation of a resource at a first location in a first map associated with a first address space, where the first location has a first address in the first address space and an association between the first address space and a network identifier space includes an association between the first address and a network identifier for accessing the resource. The computer program also includes executable instructions for receiving a request to present a second representation of the resource in a second map associated with a second address space and for translating the first address in the first address space to a second address in the second address space based on a relationship associating the first address space with the second address space, where translating the first address to the second address includes establishing an association between the second address and the network identifier based on the association between the first address and the network identifier. The computer program also includes executable instructions for presenting the second representation of the resource in the second map at a second location having the second address.

### BRIEF DESCRIPTION OF THE DRAWINGS

Advantages of the subject matter described will become apparent to those skilled in the art upon reading this description in conjunction with the accompanying drawings, in which like reference numerals have been used to designate like or analogous elements, and in which:

FIG. 1 is a flow diagram illustrating a method for associating resources of a first geospace with a second geospace according to an aspect of the subject matter described herein;

FIG. 2 is block a diagram illustrating a system for associating resources of a first geospace with a second geospace according to another aspect of the subject matter described herein;

FIGS. 3A and 3B are diagrams illustrating exemplary sliding map graphical user interfaces according to another exemplary aspect of the subject matter described herein;

FIGS. 3C and 3D are diagrams illustrating exemplary tab map graphical user interfaces according to another exemplary aspect of the subject matter described herein; and

FIG. 4 is a block diagram illustrating an arrangement providing an exemplary execution environment for components in a system for associating resources of a first geospace with a second geospace according to another exemplary aspect of the subject matter described herein.

### DETAILED DESCRIPTION

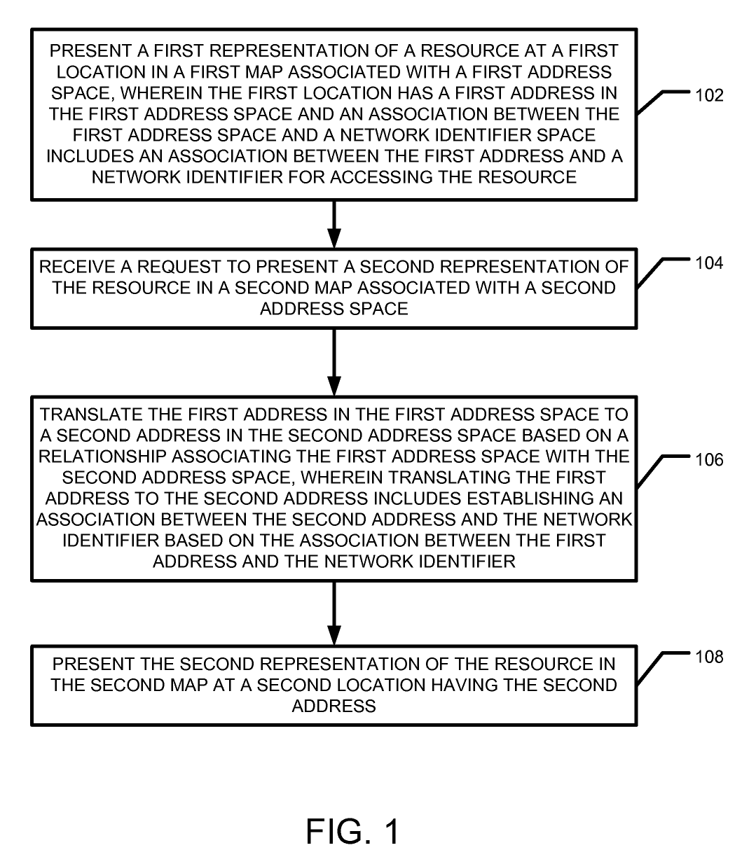

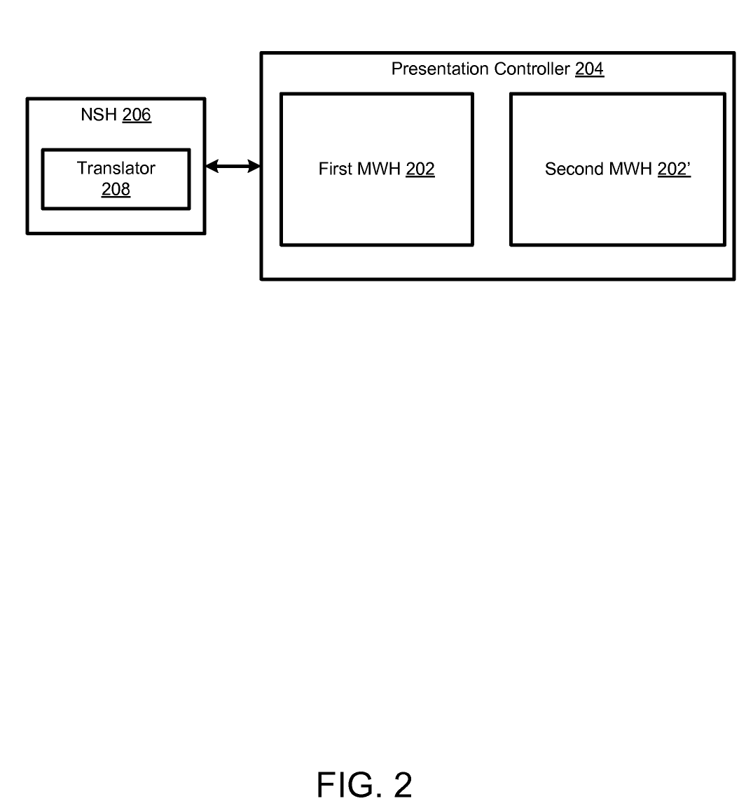

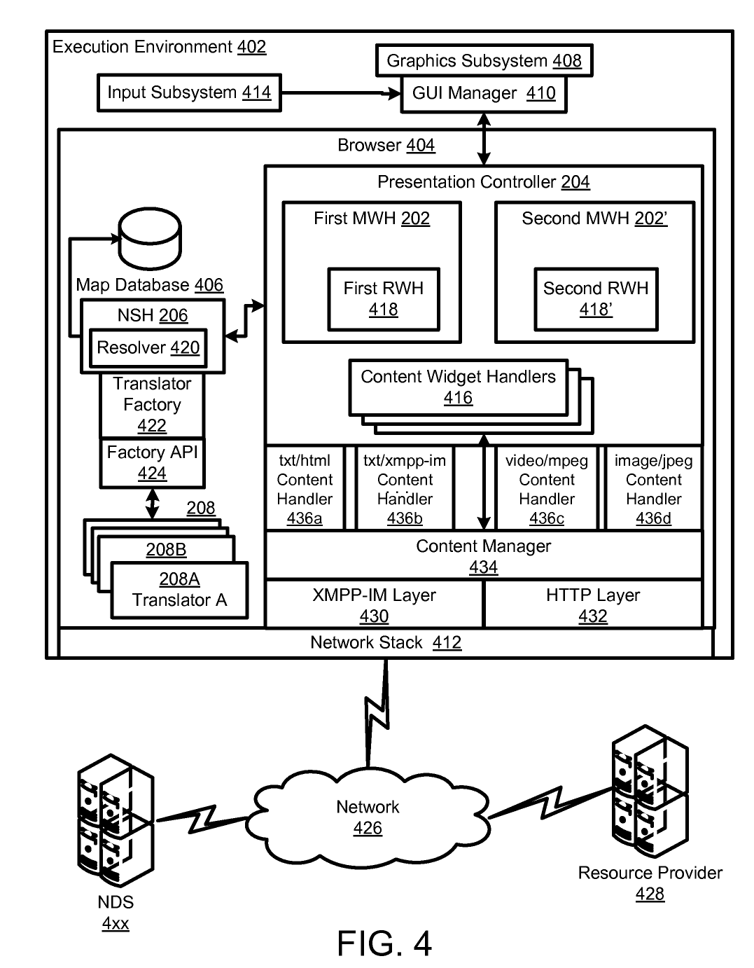

FIG. 1 is a flow diagram illustrating a method for associating resources of a first geospace with a second geospace according to an exemplary aspect of the subject matter described herein. FIG. 2 is a block diagram illustrating an arrangement of components for associating resources of a first geospace with a second geospace according to another exemplary aspect of the subject matter described herein. FIG. 4 is a block diagram illustrating an arrangement of selected components included in an execution environment provided by a device configured to host the arrangement of components illustrated in FIG. 2 or a functionally analogous arrangement of components. Accordingly, the method illustrated in FIG. 1 can be carried out by, for example, some or all of the components illustrated in FIG. 2 operating in a compatible execution environment, such as the execution environment illustrated in FIG. 4.

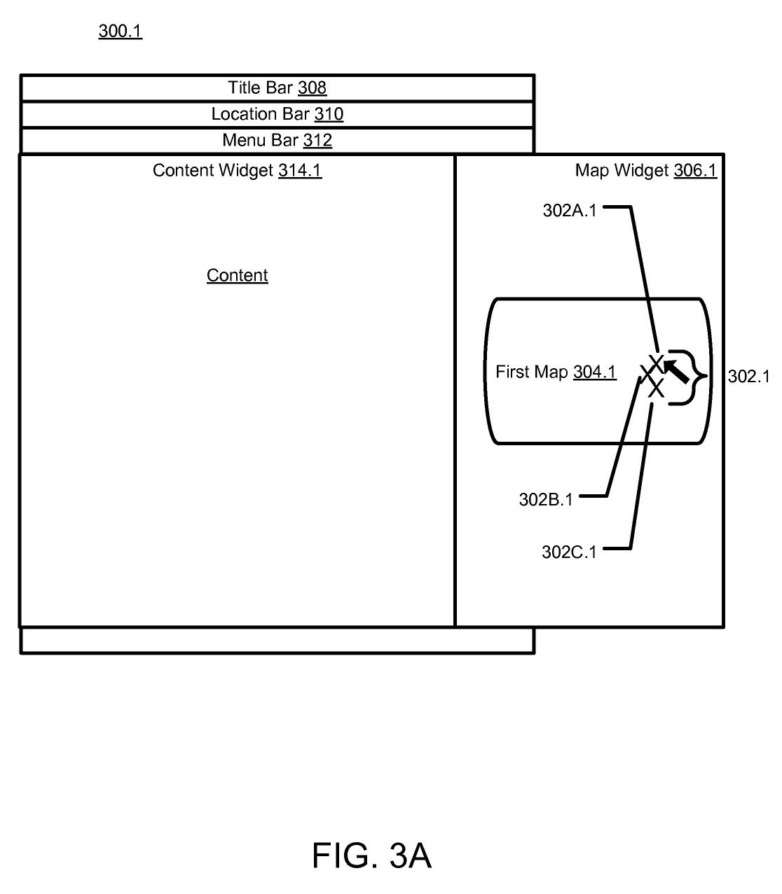

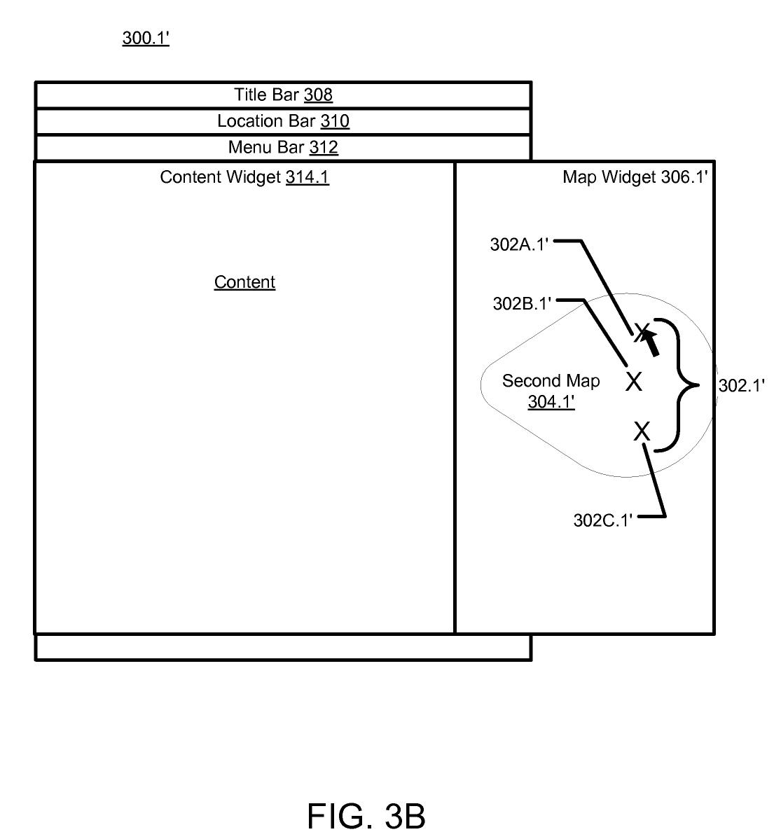

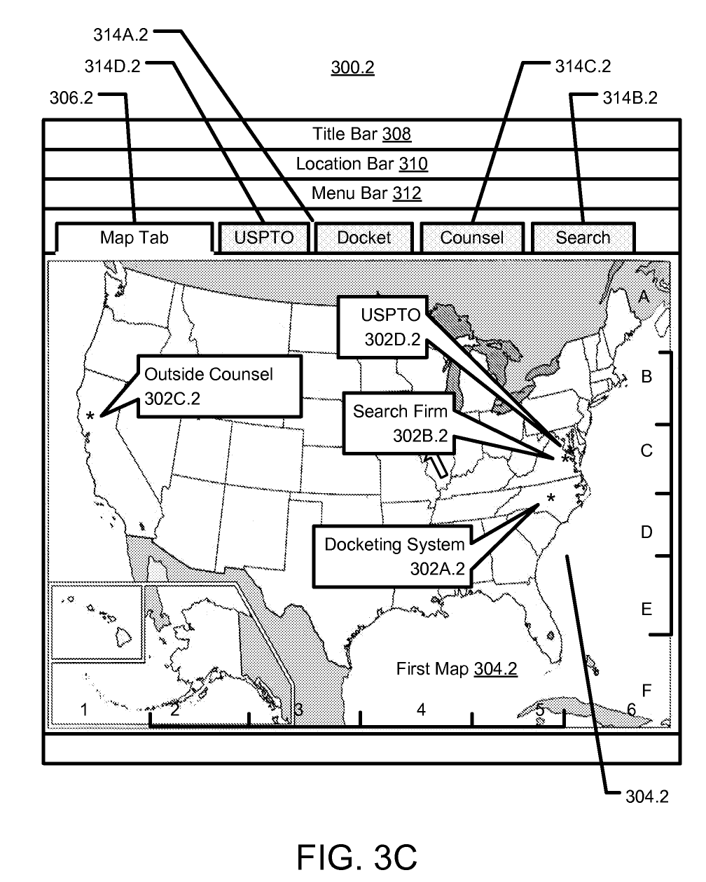

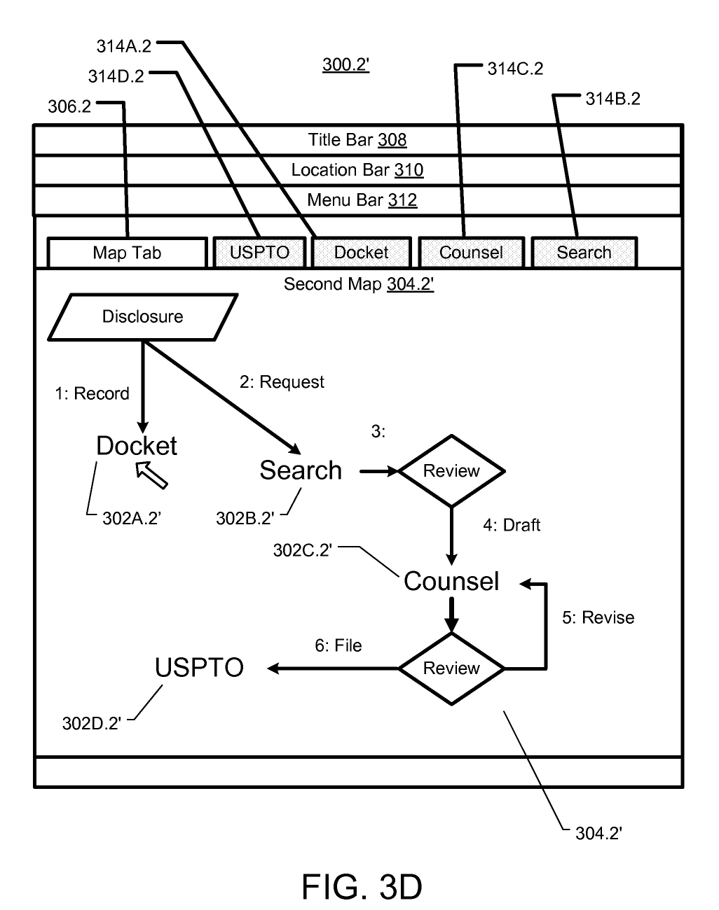

Exemplary graphical user interfaces (GUI) are depicted as a sliding map GUI 300.1 in FIGS. 3A and 3B and a tab map GUI 300.2 in FIGS. 3C and 3D. Widgets 302.1, 302A.1, 302B.1, 302C.1, 304.1, 306.1, and 314.1 in the sliding map GUI 300.1 are denoted with a “0.1” postfix to distinguish them from analogous widgets 302.2, 302A.2, 302B.2, 302C.2, 304.2, 306.2, and 314.2 in the tab map GUI 300.2 denoted with a “0.2” postfix. The use of a reference numeral without a postfix, such as 300 or 302, refers to the respective widget in either or both of the sliding map GUI 300.1 and the tab map GUI 300.2. In addition, the “′” (prime) notation is used to indicate a widget associated with a second location or second map, as will become more apparent below.

With reference to FIG. 1, in block 102 a first representation of a resource is presented at a first location in a first map associated with a first address space. The first location has an address in the first address space. An association between the first address space and a network identifier space includes an association between the address and a network identifier for accessing the resource. Accordingly, a system for associating resources of a first geospace with a second geospace includes means for presenting a first representation of a resource at a first location in a first map associated with a first address space, wherein the first location has a first address in the first address space and an association between the first address space and a network indentifier space includes an association between the first address and the network identifier for accessing the resource. For example, as illustrated in FIGS. 2 and 4, a first map widget handler component (MWH) 202 is configured to present a first representation of a resource at a first location in a first map associated with a first address space.

As illustrated in the GUIs 300 in FIGS. 3A, 3B, 3C, and 3D, the first MWH component 202 can be configured to present a representation of a resource at a first location 302A in a first map 304 presented in a map widget 306. The first map 304 is associated with a first address space, examples of which are provided below. The first address space has an association with a network identifier space. The association can be direct or indirect as described in more detail below. The first location 302A is associated with the first address in the first address space. The association of the first address space and the network identifier space includes an association between the first address and a network identifier in the network identifier space. The resource associated with the representation at the first location 302A is accessible based on the network identifier associated with the first address.

For example, a received user input such as a mouse click associated with the representation at the first location 302A can be defined to indicate a request to access the resource represented. The resource associated with the representation can be accessed based on input information associated with the received user input including the first address of the first location 302A in the first map 304 of the representation as is described in more detail below. In one aspect, the methods, systems, and program products described in above-identified application Ser. No. ______ (Attorney Docket No I496/US) can be employed for providing a map for browsing.

Each of the depicted GUIs 300 includes a title bar widget 308, a location bar widget 310 configured to present and receive user entered uniform resource locators (URL) for navigating, and a menu bar widget 312, as is common in current browsers. Each of the title bar widget 308, the location bar widget 310, and the menu bar widget 312 can be associated with a corresponding widget handler (not shown) configured to present each of the widgets and to process input information received in association with each widget. A presentation controller 204 can be configured to instantiate widget handlers corresponding to a a portion of the widgets in the GUI 300. The remaining portion of GUI 300 can be instantiated by other widget handler instances and/or by other components of a browser.

The first MWH component 202 is further configured to receive input information for selecting a resource via the representation at the first location 302A of the resource for providing an indication to the browser to access the associated resource. The selected representation presented at the first location 302A is associated with a first address. The first location 302A is associated with a network identifier via an association between the first address and the network identifier. The network identifier is included in a network identifier space associated with the first address space. The resource is accessible based on the network identifier for presenting in a content widget 314 as described in more detail below.

A navigation space handler (NSH) 206 can be configured to determine a network identifier based on the first address associated with the first location 302A in the first map 304. Exemplary methods, systems, and program products for performing the determination are described in above-identified application Ser. No. 12/170,281 (Attorney Docket No I522/US); application Ser. No. 12/170,829 (Attorney Docket No I523/US)”; application Ser. No. 12/170,833 (Attorney Docket No I524/US); application Ser. No. ______ (Attorney Docket No I527/US); and Application No. (Attorney Docket No I515/US).

FIG. 4 is a block diagram illustrating an arrangement of components providing an exemplary execution environment for components illustrated in FIG. 2. The components illustrated in FIG. 2 for performing the method illustrated in FIG. 1 can be configured to operate in a variety of applications and/or execution environments. A variety of execution environments are suitable for hosting an application including an arrangement functionally equivalent to the components illustrated in FIG. 2. The exemplary execution environment 402 illustrated in FIG. 4 includes an instruction execution machine (not shown), such as a processor for executing machine code instructions of applications such as the browser 404, a memory (not shown) for storing at least a portion of the instructions and data to be accessed by the instruction execution machine for executing, an operating system (not shown) for managing execution environment resources provided by various hardware components of a hosting device, and software subsystems for accessing and managing the various hardware components. Exemplary hardware components include a persistent storage device such as a hard drive or a removable media drive, a display and graphics adapter, a speaker and audio adapter, a network adapter, and/or other components as required by hosted applications. Exemplary software subsystems include a file and/or database subsystem that stores a map database 406, a graphics subsystem 408 with an associated GUI manager 410, a network subsystem including a network stack 412, and an input subsystem 414 configured to receive and route input received from one or more input devices and/or built-in user input controls.

The list of execution environment components is not exhaustive and other configurations are capable of supporting applications including functional equivalents of the arrangement of components illustrated in FIG. 2. Exemplary devices that can be configured with an execution environment capable of hosting an arrangement configured to perform the method illustrated in FIG. 1 include a notebook computer, a wireless communication device such as a mobile phone, a desktop PC, a server, and a remote device, and a dumb terminal configured to exchange input and output information with the remote device.

The GUI 300 is illustrated as the first sliding map GUI 300.1 in FIG. 3A and as the second sliding map GUI 300.1′ in FIG. 3B and the first MWH component 202 as illustrated in FIG. 4 is configured to present the representation of a resource at the first location 302A.1 in the first map 304.1. The first MWH component 202 includes a first presentation region provided by the GUI manager 410 for storing a presentable representation of the first map 304.1 for display in the first map widget 306.1. A MWH component, such as the first MWH component 202, can be configured to present a map widget in the first sliding map GUI 300.1 so that the first map widget 306.1 appears to slide in and out from under the content widget 314.1. A content handler component 416 can be configured to present a corresponding content widget 314.

Alternatively, as illustrated in FIG. 3C, the MWH 202 can be configured to present a first tab widget 306.2 in the first tab map GUI 300.2 in a fixed position with respect to any visible content tab widgets 314.2. Further the presentation controller 204 can be configured to provide for accessing and presenting any resources with corresponding representations presented at first locations 302A-D.2 in the first map 304.2 via interoperation with the first MWH 202 and one or more content widget handlers 416. A content widget handler 416 is configured to present an accessed resource as content in an associated content widget 314. Those skilled in the art will understand that the sliding map GUI 300.1 and the tab map GUI 300.2 are merely two exemplary arrangements of GUI widgets and widget handlers that can be presented for performing method illustrated in FIG. 1.

As described in above-identified application Ser. No. ______ (Attorney Docket No I496/US), a map 304 can be provided for various purposes, such as for navigating resources hosted by resource providers included in a network, for presenting marks on a map 304 as bookmarks also known as map marks, for presenting a browsing history; for presenting representations of resources associated with a task, and/or for providing a user with a sense of location while browsing a plurality of resources.

For example, in FIG. 3A, the first map 304.1 can be provided for presenting a history of a past browsing session and allowing a user to access one or more resources previously accessed in a session via representations of the resources presented at corresponding locations 302A-C.1 in the first map 304.1. In the first map 304.1, the representations at the locations 302A-C.1 can be associated with streaming media resources accessed during a past presentation session. The resource associated with a representation at the first location 302A.1 included in the first map 304.1 can be a video stream of a movie and/or a provider of the video stream the user enjoyed seeing and hearing in the presentation session.

In the first map 304.2 depicted in FIG. 3C and FIG. 3D, the resources associated with the representations at the first locations 302A-D.2 can be associated with a task or workflow, such as a patent filing process. For example, the resource associated with the first representation at the first location 302A.2 can be a docketing system for managing invention disclosures, patent applications, and issued patents.

As illustrated in FIG. 4, the presentation controller component 204 can be configured to interoperate with the GUI manager 410 to instantiate the various widget handler components required for presenting a GUI 300. Each widget handler component, such a content widget handler component 416, can be configured to interoperate with the GUI manager 410 for presenting an associated widget, such as a content widget 314. The GUI manager 410 can be configured to instruct the graphics subsystem 408 to “draw” or create representations of each widget in, for example, a presentation region in a display buffer provided by a graphics adapter (not shown). The graphics adapter controlled by the GUI manager 410 via the graphics subsystem 408 can be configured to interoperate with a display device (not shown). The display device can be configured to present graphical and text representations based on representations in one or more presentation regions in one or more display buffers under the control of the display adapter and/or graphics subsystem 408. Each widget handler component can be further configured to receive input information associated with an associated widget via the GUI manager 410 interoperating with the input subsystem 414.

Accordingly, the presentation controller component 204 can be configured to manage each widget handler component associated with the browser 404 to present a widget associated with each widget handler component on a display device and/or for receiving and responding to input received via the input subsystem 414.

With respect to the sliding map GUI 300.1 of FIG. 3A, the browser 404 can provide a portion of the first sliding map GUI 300.1 for receiving a selection of a past browsing session recorded and stored in an accessible storage medium. The session selection identifies session information that can include map information identifying one or more maps 304 presented during or otherwise associated with the session, and resource information identifying one or more resources accessed during the session. The selection can be determined via an input indication received via the input subsystem 414. The input information can be provided to the GUI manager component 410 by the input subsystem 414. The GUI manager component 410 can correlate the input information with a widget presented on the display at the time the input was detected. Based on the correlation, the GUI manager component 410 can identify a widget handler component for receiving input information based on the received input indication and/or based on the state of a presented widget. In this manner, an input associated with a presented session selection interface can be provided to the presentation controller component 204 and/or a widget handler component included in or managed by the presentation controller component 204.

Alternatively or additionally, the browser 404 in a similar manner can provide a portion of the first tab map GUI 300.2 for receiving a selection of a task to be performed. Alternatively or additionally, the browser 404 can be configured to determine a task to be performed based on a received resource and/or based on a requested map 304. Task information associating a task with one or more resources and one or more maps 304 can be stored in an accessible storage medium. The task information can be pre-configured as part of the browser 404 configuration, configured by a user of the browser, and/or imported from data received from another device. The task can be identified by a task ID identifying a task information record. Task information can include map information identifying one or more maps 304 to be presented during the performing of the task and resource information identifying one or more resources that can be accessed in performing the task via corresponding representations presented at the first locations, such as first locations 302A-D.2 in the first map 304.2. A portion of the widget handlers included in the browser 404 can be configured to present a list of configured tasks.

The presentation controller component 204 via the receiving widget handler component can be configured to process received input information associated with a session or a task by accessing associated session information or task information stored, for example, in a file via a file subsystem not shown, or in a map database 406 included in the database subsystem (not shown). Based on the map information included in the accessed session information or task information, the presentation controller component 204 can be configured to provide map information to the first MWH component 202. The first MWH component 202 can be instantiated in response to receiving the map information by the presentation controller component 204. The first MWH component 202 can be configured to receive the map information during or after instantiation of the first MWH component 202. The GUI manager 410 can be configured to make a presentation region available to the first MWH component 202.

The first MWH component 202 can be configured to generate a presentable representation of the first map 304 in the presentation region based on the map information received. Resource information included in the session information or in the task information can be provided to the first MWH component 202 by the presentation controller component 204 and/or by one or more widget handler components 416. For each resource identified in the resource information, the first MWH component 202 can be configured to instantiate a resource widget handler (RWH) component 418, such as the first RWH component 418, providing information for an identified resource. Each RWH component 418 such as the first RWH component 418 can be configured to present a representation 302 such as the representation of the corresponding resource at a location 302A in the first map 304. The representation can be presented by the first RWH component 418 at a first location 302A included in the first map 304.

The first map 304, when presented, can be associated with a first presentation address space, a first map address space, and a first mapped address space. A presentation address space is an address space including an address identifying a location in a presentation region. A presentation region is a region of memory provided for storing a representation of a map for presentation on an output device such as a display. A map address space is an address space including an address identifying a location in a map irrespective of a presentation of the map. A mapped address space is an address space including an address for identifying a location in a mapped region. A mapped region is a region, such as a geospatial region, represented by the map. More details on the various address space types and their associated regions are provided below.

Each RWH component in a MHW component, including the first RWH component 418 in the first MWH component 202, can be further configured to receive input information associated with receiving a selection indication via the input subsystem 414 as described above. A RWH component 418 can be configured to determine a network identifier for accessing the resource associated with the selected RWH component 418, such as the resource associated with the first RWH component 418. For example, when selection information is received by the GUI Manager 410, the GUI manager 410 can determine a widget handler component corresponding to the received information for processing the input information. When the GUI manager 410 determines that input information corresponds to the first location in a map, such as the first map 304, the GUI manager 410 can provide input information including a first address included in the first address space to the first RWH component 418. Alternatively, the GUI manager 410 can be configured to provide the input information including the first address to the first MWH component 202 which provides the first address information to the first RWH component 418.

In response to receiving the selection input information including the first address, the first RWH component 418 can be configured to determine a network identifier associated with the first address for accessing the resource. FIG. 4 illustrates the first RWH component 418 configured to provide the first address to the NSH component 206. The NSH component 206 can include a resolver component 420 as FIG. 4 illustrates to determine the network identifier associated with the first address. The resolver component 420 can be configured to perform one or more of the methods described in above-identified application Ser. No. 12/170,281 (Attorney Docket No I522/US); application Ser. No. 12/170,829 (Attorney Docket No I523/US)”; application Ser. No. 12/170,833 (Attorney Docket No I524/US); application Ser. No. ______ (Attorney Docket No I527/US); and application Ser. No. ______ (Attorney Docket No I515/US).

Further, the resolver component 420 and or the first RWH component 418 can be configured to base the determining of the network identifier on one or more of the first presentation address, the first map address, and the first mapped address as described in above-identified application Ser. No. ______ (Attorney Docket No I496/US).

When the network identifier is determined by a previous operation of the resolver component 420 or is detected in a message, a resource, and/or received user input, the network identifier can be stored in session information described above, task information described above, and/or can be stored as any other form of metadata associated with the first map 304. Storing the network identifier avoids repeated operations by the resolver component 420. Once the network identifier is determined, the associated resource can be accessed as described in more detail below.

Returning to FIG. 1, in block 104 a request is received to present a second representation of the resource in a second map associated with a second address space. Accordingly, a system for associating resources of a first geospace with a second geospace includes means for receiving a request to present a second representation of the resource in a second map associated with a second address space. For example, as illustrated in FIG. 2, the presentation controller component 204 is configured to receive a request to present a second representation of the resource in a second map associated with a second address space.

The request can be received in response to at least one of receiving user input, receiving a response associated with a request sent, receiving an asynchronous message, and an application generated event. For example, the presentation controller component 204 can be configured to receive the request in response to at least one of receiving user input, receiving a response associated with a request sent, receiving an asynchronous message, and/or an application generated event.

In the example, the presentation controller component 204 can be configured to receive a request to present a representation of the resource at a second location 302A′ included in a second map 304′ in a GUI 300′; examples depict a sliding map GUI 300.1′ in FIG. 3B corresponding to the sliding map GUI 300.1, and a tab map GUI 300.2′ in FIG. 3D corresponding to the tab map GUI 300.2 in FIG. 3D. The examplary second map 304′ is associated with a second address space. Analogous to the first map 304, the second map 304′ can be associated with a second presentation address space, a second map address space, and/or a second mapped address space.

FIG. 4 illustrates, with respect to the GUI 300, the presentation controller component 204 configured to receive a request to present a representation of the resource presented at the first location 302A in the first map 304 at a second location 302A′ in the GUI 300′ in a second map 304′. The illustrated second map 304′ is associated with a second address space.

The request can be received in response to a user input. The user request can be received via the input subsystem 404. Input information based on the input can be provided by the input subsystem 404 to the GUI manager 410 to determine one or more widgets associated with the input information. Based on the determination, the GUI manager 410 can be configured to provide the input information to the presentation controller component 204. The presentation controller component 204, based on the input information, can determine that the input information indicates a request to present a representation of the resource presented at the first location 302A in the first map 304 at the second location 302A′ in the second map 304′. The second map 304′ is to be associated with a second address space.

Alternatively or additionally, a request to present a representation of the resource at a location 302′ in the second map 304′ associated with a second address space can be generated in response to an event or a condition detected by a component of the browser 404.

The request can be generated in response to any event or condition. In an aspect, receiving a request includes selecting the second map based on an attribute associated with the resource. For example, the presentation controller component 204 can select the second map based on an attribute associated with the resource, which can include an attribute associated with the representation 302, an associated resource, the first map 304, an event associated with a task or workflow, an attribute associated with an identified user, an asynchronous message received, and a response message received in response to a request sent by the browser 404. The attribute can be at least one of a measure of resource density in the first map, a task associated with the resource, a type of the resource, a cost associated with the resource, an owner of the resource, a security attribute of the resource, and a relationship between the resource and another resource and the like.

The first MHW component 202 can be configured to automatically determine an attribute defined as a measure of density. The measure can be determined based on the addresses of locations 302A-C.1 in the first map 304.1 corresponding to representations for resources depicted in the sliding map GUI 300.1. The first MHW component 202 can be configured to determine whether a second map 304.1′ is to be generated based on a policy or condition evaluation including the density measure as a parameter. When the policy or condition is met, the first MWH component 202 can be configured to send a request to present the representations at corresponding second locations 302A-C.1′ in the second map 304.1′ depicted in FIG. 3B to the presentation controller component 204.

Alternatively or additionally, the request can be sent to the presentation controller component 204 in response to detecting a resource or activity associated with a task or workflow. In an exemplary scenario, a resource can be received via a message such as an asynchronous message or in a response to a request sent by the browser. The message is received via a network 426 from a resource provider 428. The message is received by the network stack 412. The network stack 412 can be configured to route the message to an identified recipient including an application protocol layer, such as a presence protocol layer depicted as an Extensible Messaging and Presence Protocol (XMPP-IM) layer 430 and a Hypertext Transfer Protocol Layer (HTTP) protocol layer 432. The message can be received by a content manager component 434 included in the browser 404 from an application protocol layer or from the network stack 412. The content manager component 434 can be configured to determine a content type of data in the message. The content manager component 434 can be further configured to route data in the message to one or more content handler components 436 illustrated as the content handler components 436a-d. For example, HyperText Markup Language (HTML) formatted data can be provided to a text/html content handler component 436a to process and present in an associated browser widget via a widget handler component. Other exemplary content handler components 436 illustrated in FIG. 4 include a text/xmpp-im content handler component 436b, a video/mpeg content handler component 436c, and an image/jpeg content handler component 436d.

One or more of the content manger component 434, a content handler 436 component, and/or a content widget handler component 416 can be configured to detect a resource associated with a task or workflow based on, for example, content in the resource, a Uniform Resource Identifier (URI) associated with the resource, an identity of a provider of the resource, an input received in association with a presentation of the resource, and/or another resource received or presented in association with the received resource. The one or more of the content manger component 434, a content handler component 436, and/or the content widget handler component 416 can be configured to determine whether a second map 304′ is to be generated based on a condition or policy associated with the detecting of a resource associated with a task or workflow. When the policy or condition is met, the one or more of the content manger component 434, a content handler component 436, and/or the content widget handler component 416 can be configured to send the request to present the representation at the second location 302A.2′ in the second map 304.2′ depicted in FIG. 3C to the presentation controller component 204.

The requested representations at the second locations 302′, the second map 304′, and/or the second address space can be specified in the received request. Alternatively or additionally, the requested representations in the second locations 302′, the second map 304′, and/or the second address space can be determined by the presentation controller component 204, a second MWH component 202′, and/or the NSH component 206 based on any detectable attribute. The determination can include selecting from one or more existing representations, maps, and/or address spaces; and or generating a representation, a map, and/or an address space. Exemplary attributes for determining one or more of the requested representations at the second locations 302′, the second map 304′, and/or the second address space include an attribute of the represented resource, such as a type of the resource and/or a task associated with the resource; an attribute of the first map 304 such as a density of resource representation included in the first map 304; an attribute of the first address space and/or the first location, a preconfigured attribute, and/or an attribute accessible with an execution environment hosting an arrangement of components for performing the method illustrated in FIG. 1. More specific examples include a type attribute associated with the resource, the first resource representation presented at the first location 302 and/or the first map 304; a task associated with the resource, the first map 304, and/or the received request; a density of resource representations in a portion of the first map 304, a type of the first address space such as whether it is a sequential or a non-sequential address space, a preconfigured policy based on a user, an execution environment attribute such as a time measure.

Returning to FIG. 1, in block 106 the first address in the first address space is translated to a second address in the second address space based on a relationship associating the first address space with the second address space. Translating the first address to the second address includes establishing an association between the second address and the network identifier based on the association between the first address and the network identifier. Accordingly, a system for associating resources of a first geospace with a second geospace includes means for translating the first address in the first address space to a second address in the second address space based on a relationship associating the first address space with the second address space, where the translation includes establishing an association between the second address and the network identifier based on the association between the first address and the network identifier. For example, as illustrated in FIG. 2, a navigation space handler component (NSH) 206 is configured to translate the first address in the first address space to a second address in the second address space based on a relationship associating the first address space with the second address space, where the translation includes establishing an association between the second address and the network identifier based on the association between the first address and the network identifier.

As illustrated in FIG. 2, the presentation controller component 204 can be configured to manage the received request including invoking the NSH component 206. The NSH component 206 is configured to provide for translating an address in a first address space to an address in a second address space. The translation creates or otherwise identifies an association between the address in the first address space and the address in the second address space. An association is established between the address in the second address space and the network identifier associated with the network address in the first address space. The association established between the address in the second address space and the network identifier can be direct and/or indirect. The presentation controller component 204 can be configured to instantiate a second MWH component 202′ to receive a representation of the second map 304′. The presentation controller component 204 can be further configured to provide the first MWH component 202, the second MWH component 202′, and request information based on the received request to the NSH component 206 to perform the translation.

The NSH component 206 can be configured to determine a translator component 208 based on information associated with at least one of the first MWH component 202, the second MWH component 202′, and the request information. The information for determining the translator can include an attribute of the first address space, the first map 304, a representation of a resource presented in the first map 304, a location 302 of a resource representation, the first map 304, the second address space, the second map 304′, a representation of a resource to be presented in the second map 304′, a location 302′ of a resource representation, the second map 304′, a resource associated with a representation, and the request information.

In one aspect, translating the first address to the second address includes performing a predefined operation based on the relationship between the first address space and the second address space. The NSH component 206 can be configured to translate the first address to the second address by performing a predefined operation based on the relationship between the first address space and the second address space. When the NSH component 206 performs the predefined operation, a relationship between the first address and the second address is created or otherwise identified and an association between the second address and the network identifier associated with the first address established. For example, the first map 304.1 in FIG. 3A includes multiple first representations presented at respective first locations 302.1. The NSH 206 can be configured to provide for determining a measure of density based on the presentation address of each location 302.1 in a presentation region of the map 304.1. Where a presentable representation of the map 304.1 is stored in the presentation region. When a pre-specified condition based on the determined measure of density is met, the translator component 208 associated with the condition can be selected. Alternatively, the measure of density can be determined based on addresses in a map address space of the map locations 302.1 of the representations in the map 304.1. In yet another alternative, the measure of density can be determined based on the mapped address of each location 302.1 in a mapped region represented in the map 304.1 including the representations.

The first map 302.2 in FIG. 3D includes multiple first representations of resources respective first locations 302.2. The NSH component 206 can be configured to detect a task indicator in the request information.

In another aspect, translating the first address to the second address includes translating a first pair of reference locations in the first map to a second pair of reference locations in the second map, where a first ratio based on a pair of shortest distances between the first location and each of the first pair of reference locations and a second ratio based on a pair of shortest distances between the second location and each of the second pair of reference locations are not equal. For example, the NSH component 206 can translate the first address to the second address by translating a first pair of reference locations in the first map to a second pair of reference locations in the second map. For example, the translator component 208 can perform a translation operation that performs a formula, such as a morphing formula, based on addresses from an input address space, the first address space, to receiving addresses in an output address space, the second address space, as output of performing the formula. Alternatively, the translator component 208 can perform a translation operation based on a lookup operation mapping an address in the first address space to an address in the second address space via a pre-configured lookup table. Alternatively or additionally, the translator component 208 can be configured to perform a translation operation based on a relationship between two or more first addresses in the first address space in addition to a relationship between the first address space and the second address space.

In another aspect, the first map is associated with the first address space via a first association between the first map and a first region, the second map is associated with the second address space via a second association between the second map and a second region, the first address is associated with the first region via the first association, and the second address is associated with the second region via the second association. For example, the first map 304 can be associated with the first address space via a first association between the first map 304 and a first represented region. The first address space can include the first address associated with a first location in the first represented region. The first location in the first represented region can be associated with the first location 302A in the first map 304. In general, any map 304 can be associated with an address space via an association between the map 304 and a region represented by the map 304. The address space can include an address associated with a location in the represented region corresponding to a location 302 in the map 304. Thus, the second map 304′ can be associated with the second address space via a second association between the second map 304′ and a second represented region. The second address space can include the second address associated with a second location in the second region. The second location in the second represented region can be associated with the second location 302′ in the second map 304′.

A presentation region is a region for storing a representation of an object, such as a map. An address space associated with a presentation region is referred to as a presentation address space and includes a presentation address identifying a presentation location in the presentation region. The presentation location corresponds to a map location of the represented object, such as the map location 302A. Exemplary presentation regions include a presentation region provided by a graphics subsystem for storing a visual representation of a map for presentation via a display device, and a portion or “region” of a database for storing a persistent representation of the map.

In an aspect, the first region and the second region are each at least one of a presentation region associated with a presentation address space including a presentation address for identifying a presentation location in the presentation region for storing a presentable representation of a map including a map location corresponding to the presentation location, a mapped region associated with a mapped address space including a mapped address for identifying a mapped location in the mapped region represented by the map including a map location corresponding to the mapped location; and a map region associated with a map address space for identifying a map location in the map region.

For example, an address space can be a presentation address space. The presentation address space can include a presentation address for identifying a presentation location in a presentation region associated with a map. The presentation region can be associated with the map by storing a presentable representation of a resource at a location 302 in the map 304 corresponding to the presentation location identified by the presentation address. Thus, the first address space can be a presentation address space. The presentation address space can include a first presentation address for identifying a first presentation location in the presentation region including a presentable representation of the first location 302 in the first map 304. The presentation address space can be the first address space including the first presentation address as the first address associated with the first location 302. Similarly, the second address space can be a presentation address space. The presentation address space can include a second presentation address for identifying a second presentation location in the presentation region including a presentable representation of the second location 302′ in the second map 304′. The presentation address space can be the second address space including the second presentation address as the second address associated with the second location 302′.

As used herein, a “map region” is a region in a map and a map is a representation of a space or region commonly in the real world. A map is itself a map region. A space or region represented by a “map region” can be referred to as a “mapped region” as it is mapped to a map. An address space associated with a map region is referred to as a map address space and includes a map address identifying a map location in the map region. Since a region associated with the map 304 can be a region represented by the map, referred to as a mapped region, an address space associated with a mapped region can be referred to as a mapped address space and includes a mapped address identifying a mapped location in the mapped region. A mapped location corresponds to a location in the map 304, such as the first location 302A. In addition, the terms “regions” and “location” can be used interchangeably. Location typically refers to a smaller region within a relatively larger region. The term region can refer to a mapped region, a map region and/or a presentation space region depending on the context. The term “location” is used analogously. The term “address” can similarly refer to a mapped address, a map address, and/or a presentation space address depending on the context.

For example, the real region of Earth known as North Carolina can be a mapped region when represented in a map 304. The real region of North Carolina is associated with an address space including identifiers of counties in North Carolina. “Wake County” identifies a real location in North Carolina, and is, thus, a mapped identifier in the mapped address space of county names. The real region of Wake County can be represented in the map at a location 302 in the map identified by the map address, “Wake County”.

For example, an address space can be a mapped address space that includes a mapped address for identifying a mapped location in a mapped region represented by a map 304. The mapped region is associated with the map 304 via a representation of the mapped location identified by the mapped address in a location 302 in the map 304. Thus, the first address space can be a mapped address space. The mapped address space can include a first mapped address for identifying a first mapped location in the mapped region represented in the first map 304 at the first location 302.

In another aspect, the first address space is a mapped address space including a first mapped address for identifying a mapped location in a mapped region represented at the first location 302A in the first map 304 and the second address space is a mapped address space including a second mapped address for identifying a mapped location in a mapped region represented at the second location 302A′ in the second map 304′. For example, the mapped address space can be the first address space including the first mapped address as the first address associated with the first location 302. Similarly, the second address space can be a mapped address space that includes a second mapped address for identifying a second mapped location in the mapped region represented in the second map 304′ at the second location 302′. The first map 304 and the second map 304′ can represent a common mapped region, where the first address space and the second address space are different mapped address spaces associated with the common mapped region and the mapped location identified by the first mapped address and the mapped location identified by the second mapped address include a common mapped location in the common mapped region. Alternatively, the mapped location identified by the first mapped address and the mapped location identified by the second mapped address can include no common mapped location in a common mapped region included in the mapped region represented at the first location 302A in the first map 304 and the mapped region represented at the second location 302A′ in the second map 304′.

In another aspect, the first address space is a map address space including the first address for identifying the first location 302A in the first map 304 and the second address space is a map address space including the second address for identifying the second location 302A′ in the second map 304′. For example, the first map location can be the first location 302A where the representation of a resource is presented in the map 304. The map address space as the first address space includes the first map address as the first address associated with the first map location as the first location 302A. Similarly, the second address space can be a map address space that includes a second map address for identifying a second map location 302A′ in the map 304′. The second map location is the second location 302A′ where the representation of the resource is presented in the second map 304′. The map address space as the second first address space includes the second map address as the second address associated with the second map location as the second location 302A′.

The first map 304 and the second map 304′ can include a common map region in the first map and in the second map, the first location 302A and the second location 302A′ include a common map location in the common map region, and the first address space and the second address space are different map address spaces associated with the common map region. Alternatively, the first location and the second location can include no common map location in a common map region included in the first map region and the second map region.

The second map 304′ can be an existing map specified in the request, determined by the NSH component 206, or determined by the translator component 208. Alternatively, the second map 304′ can be generated by the translator interoperating with the second MWH component 202′.

For example, a specified mouse gesture can be defined to indicate a request to present a representation of a resource at a second location 302′ in a second map 304′. In response to the request indicated by the specified mouse gesture detected in association with a presentation of the first map 304, an operation can be performed on an address of a location 302 in the first map 304 of a representation of the resource. The operation can generate or otherwise determine a second address. Further the operation can generate or otherwise determine the second map 304′. The second address is in a second address space associated with the second map 304′. The second address identifies a second location 302′ for presenting the representation in a presentation of the second map 304′.

The operation can include a morphing translation that generates the second map 304′ that represents some or all of the mapped regions represented in the first map 304. The map region presented in the second map 304′ can be presented with a different shape in the second map 304′ than the shape of the corresponding map region presented in the first map 304. Alternatively or additionally, the operation can include a translation that generates or otherwise determines the second address, and the operation further generates and or determines the second map 304′. The second map 304′ can represent a different mapped region than the mapped region presented in the first map 304. That is, there is no common mapped region represented in the first map 304 and the second map 304′.

In the example, the mouse gesture can be detected by the input subsystem 414 and associated with the first map 304 by the GUI manager 410 interoperating with the input subsystem 414. Based on the input and the association, input information can be received by the presentation controller component 204. The presentation controller component 204 can be configured to respond to input information in accordance with the input received in association with the first map 304. The input can be associated with a menu item, toolbar button, and/or a mouse gesture associated with a first map 304 to name a few alternatives for receiving the request as user input.

In an aspect, the first address space can be a presentation address space including a first presentation address identifying a presentation location in a presentation region including a presentable representation of the first location 302 in the first map 304 and the second address space can be a presentation address space including a second presentation address for identifying a presentation location in a presentation region including a presentable representation of the second location 302′ in the second map 304′. For example, the first region can be a presentation region associated with a presentation address space as the first address space. The presentation address space includes the first address as a presentation address for identifying a presentation location in the presentation region. The presentation region is provided for storing a representation of a region of the first map 304, such as presentable representation. A representation of the first map location 302 can be stored at the presentation location. The first map location 302 is associated with the first address via the first presentation location.

Alternatively or additionally, the first region can be a mapped region associated with a mapped address space as the first address space. The mapped address space includes the first address as a mapped address identifying a mapped location in the mapped region. The mapped region is represented by a region in the first map 304. The first map location 302 can include a representation of the first mapped location. The first map location 302 is associated with the first address via the mapped location.

Alternatively or additionally, the first region can be a map region associated with a map address space as the first address space. The map address space includes the first address as a map address identifying the first map location 302 in the region in the first map 304. The first map location 302 is associated with the first address as an identifier. For example, many highway maps 304 are presented with a grid including horizontal and vertical lines. Each cell region in a grid can be located on a map given a first identifier of a vertical region between two vertical lines and a second identifier of an intersecting horizontal region between two horizontal lines. An identifier for a location included within a cell can be expressed based on a coordinate pair including an identifier of a vertical region and an identifier of an intersecting horizontal region. In the GUI 300.2, a representation of a resource is depicted at the location 302A.2 in the map 304.2 associated with a map address D6. ‘D’ indicates a horizontal region including the location 302A.2 of the representation and ‘6’ indicates a vertical region including the location 302A.2. Thus, the representation 302A.2 is located in a cell associated with the map address D6 associated with the first map 304.2, as indicated. The first location of the first representation 302A.2 is associated with the first address serving as a map address included in a first address space serving as a map address space associated with the first map 304.2. The first map address identifies the first location 302A.2 regardless of whether the first map 304.2 is presented on a display device or on paper. As described, the first address can be in the form of a coordinate pair identifying a cell including at least a portion of the first location 302A.2.

In a further aspect, the presentable representation of at least a portion of the first map and the presentable representation of at least a portion of the second map can be stored in a common presentation region, where the first presentation address space and the second presentation address space are different presentation address spaces associated with the common presentation region and the presentation location identified by the first presentation address and the presentation location identified by the second presentation address include a common presentation location in the common presentation region.

Alternatively, the presentation location identified by the first presentation address and the presentation location identified by the second presentation address include no common presentation location in a common presentation region included in the presentation region including a presentable representation of the first location in the first map and the presentation region including a presentable representation of the second location in the second map.

For example, the first MHW component 202 can be configured to present the first map 304 in a first presentation region serving as the first region associated with a first presentation address space serving as the first address space. An exemplary first presentation address space includes presentation addresses that can be formatted as two-dimensional coordinate addresses. In the exemplary first presentation address space, each pixel of a display device is represented in the first presentation region. Each pixel can be associated with a presentation coordinate address included in the first presentation address space. A presentation region is a representation of a region of a visual output device, such as a display, for creating and storing a visual representation of a corresponding map. A presentation region can be specified as including one or more smallest addressable locations such as one or more pixels. Alternatively or additionally addressable locations can be addressed at one or more higher layers of abstraction than pixels. When represented in the first presentation region, each first map location 302 in the first map 304 is associated with a corresponding first presentation region location for storing a representation of a resource for presentation at the first map location 302. Thus, one or more presentation addresses included in a first presentation address space can be associated with one or more corresponding map addresses included in a map address space. A relationship between a smallest presentation addressable location and map addressable location can be defined that is one-to-one, one-to-many, many-to-one, or stated generally, m-to-n. A presentation addressable region including more than one smallest presentation addressable location can be associated with a map addressable region including a different number of smallest map addressable locations. The first location 302 of the first representation of the resource when presented can be associated with a first presentation address included in the first presentation address space. Through associations between map locations 302 and presentation region locations, a map 304 can be associated with the presentation address space.

A map address space can be associated with a map persistently while a presentation address space can be associated with the map during a presentation of the map. Thus, over time a map can be associated with multiple presentation address spaces and/or have multiple associations with the same presentation address space each at a different time while retaining its association with a single map address space.

In another aspect, at least one of the first address space and the second address space is a geospatial address space associated with a mapped geospatial region including a mapped location represented by at least one of the first location included in the first map and the second location included in the second map, and the at least one of the first map and the second map represent the geospatial region.

For example, a map 304 can be a representation of a mapped entity such as geospatial region. The terms “entity” and “region” are used interchangeably in this document in the context of mapping. A mapped region can be associated with an address space referred to in this document as a mapped address space. A mapped address in a mapped address space associated with a region identifies a location in the region without need of a map. Mapped regions include real geospatial regions such as the United States, Earth, and the Milky Way galaxy. Example mapped address spaces include the United States Postal Service delivery street address space, a GPS address space supporting either one, two, or three dimensions; a geopolitical address space such as space of addresses including country identifiers, state province identifiers, county/parish identifiers, and/or municipality identifiers. Mapped regions also include abstract or virtual regions such as found in video games or the World Wide Web associated with a HTTP URL address space. An abstract or virtual region can be a map representing a real geospatial region or another abstract or virtual region. When a map is associated with a region associated with a mapped address space, mapped locations in the mapped region are represented by corresponding map locations in the map.

Through corresponding locations as described in the previous paragraph, a map representing a region associated with a mapped address space is associated with a mapped address space. A location associated with the map address is also associated with the mapped address included in the mapped address space. For example, the first MWH component 202 can include map information for the first map 304.2 including a represented mapped region of the United States including North Carolina. The mapped region can be associated with a first mapped address space, for example, based on the U.S. Post Office street address space by the first MWH component 202 so configured. The first map location 302A.2 in the first map 304.2 can be configured to represent a first mapped location included in the mapped region identified by a first mapped address, a first US postal address, included in the first mapped address space based on the US postal address space. The first mapped address can be a geospatial address or a non-geospatial address depending on the type of region mapped.

As with map locations and presentation region locations, a relationship between a smallest mapped addressable location and smallest addressable map addressable location can be one to one, one-to-many, many-to-one, or many-to-many. A mapped addressable region including more than one smallest mapped addressable location can be associated with a map addressable region including a different number of smallest map addressable locations.

The first address space can be a first mapped address space, a first map address space, or a first presentation address space. The first map 304 can be associated with one or more types of addresses spaces at any point in time as just described above. Based on relationships among a presentation address space, a map address space, and a mapped address space associated with a map, an address from any one of the address spaces is associated with an address in each of the other address spaces. Thus, given an address in one of the address spaces, corresponding addresses in each of the other address spaces associated with the map can be determined based on the existing relationships among the address spaces.

The first address space associated with the first map 304 is associated with a network identifier space. If this is true for one type of address space associated with the first map 304, it can be true for any other address spaces associated with the first map 304 as just described. For example, the current domain name system (DNS) provides support for a LOC record. A LOC record associates a network identifier in the form of an IP address with a geospatial location creating an association between a geospatial address space including an address stored in a LOC record and the network identifier space in the form of an IP network address. The association of the geospatial address space, in this example, with the IP network address space includes an association between a first geospatial address associated with a first geospatial location in the real world with an IP address of a network node associated with the first geospatial address. Thus a relationship exists from an IP address space to a geospatial address space. While the current DNS enables the first geospatial location to be determined given the IP network address, there is no support for determining the IP network address given the first geospatial location. Methods, systems, and program products are described in above-identified application Ser. No. 12/170,281 (Attorney Docket No I522/US); application Ser. No. 12/170,829 (Attorney Docket No I523/US)”; application Ser. No. 12/170,833 (Attorney Docket No I524/US); Application No. (Attorney Docket No I527/US); and/or application Ser. No. ______ (Attorney Docket No I515/US) for determining a network identifier based on location information identifying an address included in an address space. Via a network identifier, such as the IP address associated with the first mapped location, communication can be established with a network node associated with the IP network address where the network node is configured to provide access to the resource represented by the first representation 302 included in the map 304 at the first location. The methods, systems, and program products described in those above-identified applications are applicable to any network identifier space associated with any region whether geospatial or non-geospatial, real or virtual.

For example, the first MWH component 202 can be configured to present a region of the United States, such as North Carolina. The presented first map 304.1 can be associated with a presentation address space, a first map address space such as a grid coordinate address space displayed in association with the first map 304.1 discussed above, and/or a mapped address space such as the U.S. Postal Service street address space also discussed above. The first location can analogously be a first presentation location associated with a first presentation address included in the first presentation address space, a first map location 302 associated with a first map address such as a first grid coordinate pair included in the first map address space, and a first mapped location associated with a first mapped address such as postal address included in the U.S. postal service address space. The first presentation location, first mapped location, and first map location 302 correspond to one another as described above. Given a first location from among of the three locations, any of the other two first locations can be determined based on relationships among the first address spaces as also described above.

The term “first location” is used in this document to refer to any of a map location a presentation space location, and/or a mapped location. Analogously, the term “first address” is used in this document to refer to first address of the referenced map location, presentation space location, and/or mapped location. Via one or more of the methods, systems, and program products described in those above-identified applications, the first presentation address, the first map address, and/or the first mapped address is associated with a network identifier such as a network name or network address included in a network identifier space, such as the DNS name space or the IPv4 or IPv6 network address space. Thus, each of the first locations is associated with the network identifier of the resource represented at the first locations.

In FIG. 4, the presentation controller component 204 can be configured to manage the received request invoking the NSH component 206 configured to provide for translating resource representations presented at first locations 302 included in the first map 304 to second representations presented at second locations 302′ included in a second map 304′. The presentation controller component 204 can be configured to instantiate a second MWH component 202′ to present the second map 304′ as described above. The presentation controller component 204 can be further configured to provide the first MWH component 202, the second MWH component 202′, and request information based on the received request to the NSH component 206 to perform the translation. The NSH component 206 can be configured to retrieve resource information as described above from the first RWH component 202 and resource information for a representation 302 associated with a first RWH component 202. As described above, the second map 304′ and/ or the second address space can be specified in the request information, preconfigured by a portion of the browser 404 configuration, or generated dynamically based on an operation performed by a translator component 208.as described above, or generated dynamically as described below.

The NSH component 206 illustrated FIG. 4 can be further configured to provide one or more attributes of the first address space, one or more attributes associated with a represented resource and/or a representation of the resource, and/or a parameter based on the request information to a translator factory component 422 configured to select a translator component 208. The translator factory component 422 can provide a factory application programming interface (API) component 424. The factory API can be configured to receive registration requests from translator components 208, to invoke translator components 208, and to otherwise interoperate with translator components 208. Translator components 208 can be managed as plug-in components as illustrated in FIG. 4. One or more translator components 208 can be supported via the translator API component 424.

For example, the first map 304.1 depicted in the sliding map GUI 300.1 includes multiple first representations 302.1. The translator factory component 422 can be configured to determine a measure of density based on the location 302.1 of each resource representation in the first map 304.1 as presented in the GUI 300.1. Alternatively, a translator component 208A can be configured to determine the measure of density. When a pre-specified condition based on the determined measure of density is met, the translator component 208A can be selected.

Alternatively, the first map 304.2 depicted in the tab map GUI 300.2 includes multiple first representations 302.2. The translator factory component 422 can be configured to determine a task is associated with one or more of the resources represented in the first locations 302.2 in the first map 304.2. Alternatively, a translator component 208B can be configured to determine a task is associated with one or more of the resources represented in the first map 304.2. In response to determining that a task is associated with one or more of the resources represented in the first map 304.2, the translator component 208B can be selected by the translator factory component 422.

The translator component 208B can be configured to translate the first address included in the first address space associated with the first location 302.2 of the representation of the resource to a second address included in the second address space based on a determined and/or specified relationship associating the first address space with the second address space. The relationship can be determined based on a task associated with a the first map 304.2, a represented resource in the first map 304.2, or based on information associated with the request to present the second map 304.2′. The translator component 208B can be configured to perform a translation of an input address space, the first address space, to an output address space, the second address space based on resources associated with locations and an order or workflow sequence defined for the task. The translator component 208B can be configured to use an existing second map 304.2′ configured to present task related resource representations. Alternatively, the translator component 208B can be configured to generate the second map 304.2′ based on, for example, the number of resources included in the task, and/or the relationships among the resources in a workflow associated with the task. Translator component 208B can be configured to select the second map 304.2′ based on the particular task. The translator component 208B can be configured to translate an address in the first address space to an address in the second address space to determine a location 302.2′ locating the representation of the resource in the second map 304.2′. Locations in the first map 304.2 not associated with a representation can be ignored by the translator component 208B. In one alternative, a second address is determined based on the resource's order in a work flow associated with the task, the number of resources, and an attribute of the second map 304.2′. The translation operation does not require the first address to determine the second address. A translation from the first address to the second address can occur as a side effect of the operation of the translator component 208B

The first map 304.2 depicts four representations of resources at four respective locations 302A-D.2. There is no indication of a task associated with more than one of the representations of the resources. The second map 304.2 illustrates a work flow associated with the representations of the resources. Order of resource access is illustrated along with an action associated with each resource in a step on the workflow. For example, the work flow begins with a disclosure document. A next step in the workflow labeled with “1” indicates the disclosure is recorded in the docketing resource depicted as the “Docket” representation 302A.2′.

The address space associated with each location of each representation can be a different address space, or two or more share the same address space associated with a first map 304.

The first map 304 can represent a mapped geospatial region such as depicted in the sliding map GUI 300.1 in the first map 304.1. In the first map 304.2, the first map location 302A.2 corresponds to a first mapped location, a company location in Raleigh, N.C. The first map location 302A.2 also corresponds to a first presentation region location when the first map 304.2 is presented. A server hosting the docketing system is situated at the first mapped company location in Raleigh, N.C. The resources associated with a representation of a search firm, a representation of a law firm resource serving as outside counsel to the Raleigh company, and a representation of a United States Patent and Trademark Office (USPTO) resource are presented in the first map 304.2 at locations 302B.2, 302C.2, and 302D.2, respectively. In FIG. 3D, a resource associated with each representation has been accessed and each is displayed in a content page/tab widget 314.2. The docketing system resource is associated with the representation at the location 302A.2. The docketing system resource is presented in a “Docket” page/tab widget 314A.2. The resource associated with the representation at the location 302B.2 is accessed from a network node of the search firm. The search firm resource is presented in a “Search” page/tab widget 314B.2. The resource associated with the representation at the location 302C.2 is accessed from a network node of the law firm serving as outside counsel for the company owning the docketing system. The resource associated with the outside counsel is presented in a “Counsel” tab widget 314C.2. The resource associated with the representation at the location 302D.2 is accessed from a network node of the United States Patent and Trademark Office. The USPTO resource is presented in a “USPTO” tab widget 314D.2. Each content page/tab widget 314.2 is associated with a content page/tab widget handler component 416 configured to present a resource in a presentation region associated with each content page/tab widget 314.2.

As described above, different types of address spaces can be associated with a map 304 at any given time. The first map 304 can be associated with a first presentation address space, a first map address space, a first mapped address space. One or more of the first address spaces can be the same address space. The mapped address space can be a portion of a GPS address space. The GPS address space can also perform the role of a map address space. Analogously, the first presentation address space can be a two-dimensional address space of horizontal dimension and vertical dimension pairs. The same address space can be used as the first map address space. The same coordinate system can be used as the first mapped address space instead of or in addition to the GPS address space. In the GUI 300.2, the first mapped address space is the U.S. Postal Service street address space. The first map address space can be a grid based system shown in the first map 304.2 as described above with regions between horizontal lines identified by capital letters starting at ‘A’ at the top of the first map 304.2, and vertical regions identified by integers beginning with ‘1’ on the left of the first map 304.2. The first presentation region can be associated with a two-dimensional Cartesian coordinate system as a presentation address space. The top, left pixel can be configured as the origin with the address (0, 0).

The first MHW component 202 can be configured to present the first map 304.2 by associating each grid in the first mapped address space to a region of pixels in the first presentation region addressed by the first presentation address space. Note that zoomed presentations of the first map 304.2 alter the association of each grid in the first mapped address space with a region of pixels in the first presentation region. That is a region of pixels changes size based on a zoom level changing the presentation locations of corresponding map locations. The map address space remains unchanged in addressing locations and regions in the first map 304.2 while the presentation address space addresses corresponding to the map locations and regions changes. The mapped address space retains its associations with the mapped region and with the map address space in this particular example. The first map location 302.2 can be associated with at least a portion of a grid region associated with a grid identifier included in the first map address space. The first mapped location can be associated with a street address included the first mapped address space. When the first representation at the location 302A.2 of the docketing system resource is presented in the tab map GUI 300.2 the first map location 302A.2 and the first mapped location are associated with a first presentation region location associated with a first presentation address included in the first presentation address space. Through associations between first map locations 302.2 and first presentation region locations, the first map 304.2 is associated with the first presentation address space. An analogous example can be provided for the first map 304.1 in the sliding map GUI 300.1 or for that matter for any presented map.

In operation, the graphics subsystem 408 can be configured to provide a first presentation region and an associated first presentation address space to identify locations in the first presentation region. An application such as the browser 404 can be configured to present a user interface widget in the first presentation region at a location specified based on an address included in the presentation address space. A size of the representation can also be specified based on addresses included in the first presentation address space. The first presentation region can be provided as a two-dimensional space associated with a first presentation address space including a coordinate pair specifying horizontal position and a vertical position with respect to a predetermined reference point such as a top left corner of the presentation region. The graphics subsystem 408 can be configured to associate each pixel in the first presentation region with a coordinate pair. Examples of direction identifier types used in coordinate pairs include integer, decimal, alphabetic, or any other set of suitable identifiers. The graphic subsystem 408 can be configured to provide one, two, and or three dimensional presentation regions. While Cartesian spaces are typically used, the graphics subsystem 408 can be configured to provide other types of presentation regions and associated address spaces. For example, a curved space can be provided. Additionally, the graphics subsystem 408 can be configured to provide higher dimensional presentation regions that are presented in a two or three dimensional representation. The graphics subsystem 408 can be configured to provide a presentation address space with address components for each dimension of an associated presentation region.

Returning to FIG. 1, in block 108 the second representation of the resource is presented in the second map at a second location having the second address. Accordingly, a system for associating resources of a first geospace with a second geospace includes means for presenting the second representation of the resource in the second map at a second location having the second address. For example, as illustrated in FIG. 2, the second MWH component 202′ is configured to present the second representation of the resource in the second map at a second location having the second address.

The second address included in the second address space determined by the translation performed by the translator component 208A is returned to the NSH component 206 as are all address translations from the first address space to the second address space determined by the translator component 208A. The NSH component 206 provides the translated addresses, any representation information associated with each translated address, and map information specifying the map 304 to the second MWH component 202′ instantiated by the presentation controller component 204.

For example, the second MWH component 202′ presents a representation of the second map depicted as the second map 304.1′ in the sliding map GUI 300.1′ in FIG. 3B. The second MWH component 202′ can instantiate a second component RWH 202′ based on the resource information and the second address included in the second address space. The second RWH component 202′ can present the resource at a second location 302.1′ associated with the second address as depicted in FIG. 3B. The second MWH component 202′ can be configured to present the second map 304.1′ based on the second map information. The second MWH component 202′ can instantiate additional RWH instances for presenting each of the remaining resource representations at their locations 302B-C.1′ based on corresponding addresses included in the second address space determined by the translating operation of the translator component 208A described above.

As illustrated in FIG. 3B and described above, representations including the first representation presented in the first map 304.1 at locations 302.1 that are relatively close together. The associated locations 302.1′ in the second map 304.1′, where the corresponding representations are presented, are presented relatively far apart. Each second location 302.1′ is associated with an address included in the second address space determined by the translator component 208A based on a corresponding address included in the first address space associated with each first location 302.1 of the represented resources. The second map 304.1′ generated by the morphing translation of the translator component 208A is illustrated in the sliding map GUI 300.1′ as a morphing of the region mapped by the map 304.1 into a region with a different shape as depicted in the map 304.1′ based on a measure of density of the locations of the presented representations of associated resources.

As described above, the first location 302A.1 in the first map 304.1 is associated via the first address included in the first address space with a network identifier for accessing the resource. The association of the second location 302A.1′ and the second address with the first location 302.1 and the first address, respectively, creates an association between the second location 302.1′ via the second address with the network identifier for accessing the resource. Given the second address included in the second address space, the network identifier can be determined using one of the methods, systems, and program products described in above-identified application Ser. No. 12/170,281 (Attorney Docket No I522/US); application Ser. No. 12/170,829 (Attorney Docket No I523/US)”; application Ser. No. 12/170,833 (Attorney Docket No I524/US); application Ser. No. ______ (Attorney Docket No I527/US); and/or application Ser. No. ______ (Attorney Docket No I515/US).

In first tab map GUI 300.2 and in translated second tab map GUI 300.2′, representations of resources presented at first locations 302.2 in the first map 304.2 are presented as representations presented at second locations 302.2′ included in a second map 304.2′. Each first location 302.2 is associated with a first address in the first address space of each first map 304.2. Each first address is translated to a second address in the second address space. Representations of the resource are presented in the second map 304.2′ at the second locations 302.2′.

Relative to the second location 302′, the operations described above with reference to the first location 302 apply also to the second location 302′. For example, the input subsystem 414 can be configured to receive an input corresponding to one of the first location 302 and the second location 302′, the NSH component 206 can determine a geospatial address based on the one of the first address and the second address, and the resolver component 420 can determine the network identifier based on the geospatial address.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for associating resources of a first geospace with a second geospace, the method comprising:
presenting a first representation of a resource at a first location in a first map associated with a first address space, wherein the first location has a first address in the first address space and an association between the first address space and a network identifier space includes an association between the first address and a network identifier for accessing the resource;
receiving a request to present a second representation of the resource in a second map associated with a second address space;
translating the first address in the first address space to a second address in the second address space based on a relationship associating the first address space with the second address space, wherein translating the first address to the second address includes establishing an association between the second address and the network identifier based on the association between the first address and the network identifier; and
presenting the second representation of the resource in the second map at a second location having the second address,
wherein at least one of the preceding actions is performed on at least one electronic hardware component.

2. The method of claim 1 wherein receiving a request includes receiving the request in response to at least one of receiving user input, receiving a response associated with a request sent, receiving an asynchronous message, and an application generated event.

3. The method of claim 1 wherein receiving a request includes selecting the second map based on an attribute associated with the resource.

4. The method of claim 3 wherein the attribute is at least one of a measure of resource density in the first map, a task associated with the resource, a type of the resource, a cost associated with the resource, an owner of the resource, a security attribute of the resource, and a relationship between the resource and another resource.

5. The method of claim 1 wherein translating the first address to the second address includes performing a predefined operation based on the relationship between the first address space and the second address space.

6. The method of claim 1 wherein:
translating the first address to the second address includes translating a first pair of reference locations in the first map to a second pair of reference locations in the second map; and
a first ratio based on a pair of shortest distances between the first location and each of the first pair of reference locations and a second ratio based on a pair of shortest distances between the second location and each of the second pair of reference locations are not equal.

7. The method of claim 1 wherein:
the first map is associated with the first address space via a first association between the first map and a first region;
the second map is associated with the second address space via a second association between the second map and a second region;
the first address is associated with the first region via the first association; and
the second address is associated with the second region via the second association.

8. The method of claim 7 wherein the first region and the second region are each at least one of:
a presentation region associated with a presentation address space including a presentation address for identifying a presentation location in the presentation region for storing a presentable representation of a map including a map location corresponding to the presentation location;
a mapped region associated with a mapped address space including a mapped address for identifying a mapped location in the mapped region represented by the map including a map location corresponding to the mapped location; and
a map region associated with a map address space for identifying a map location in the map region.

9. The method of claim 1 wherein the first address space is a mapped address space including a first mapped address for identifying a mapped location in a mapped region represented at the first location in the first map and the second address space is a mapped address space including a second mapped address for identifying a mapped location in a mapped region represented at the second location in the second map.

10. The method of claim 9 wherein:
the first map and the second map represent a common mapped region;
the mapped location identified by the first mapped address and the mapped location identified by the second mapped address include a common mapped location in the common mapped region; and
the first address space and the second address space are different mapped address spaces associated with the common mapped region.

11. The method of claim 9 wherein the mapped location identified by the first mapped address and the mapped location identified by the second mapped address include no common mapped location in a common mapped region included in the mapped region represented at the first location in the first map and the mapped region represented at the second location in the second map.

12. The method of claim 1 wherein the first address space is a map address space including the first address for identifying the first location in the first map and the second address space is a map address space including the second address for identifying the second location in the second map.

13. The method of claim 12 wherein:
the first map and the second map include a common map region in the first map and in the second map;
the first location and the second location include a common map location in the common map region; and
the first address space and the second address space are different map address spaces associated with the common map region.

14. The method of claim 12 wherein the first location and the second location include no common map location in a common map region included in the first map region and the second map region.

15. The method of claim 1 wherein the first address space is a presentation address space including a first presentation address for identifying a presentation location in a presentation region including a presentable representation of the first location in the first map and the second address space is a presentation address space including a second presentation address for identifying a presentation location in a presentation region including a presentable representation of the second location in the second map.

16. The method of claim 15 wherein:
a presentable representation of at least a portion of the first map and a presentable representation of at least a portion of the second map are stored in a common presentation region;
the presentation location identified by the first presentation address and the presentation location identified by the second presentation address include a common presentation location in the common presentation region; and
the first presentation address space and the second presentation address space are different presentation address spaces associated with the common presentation region.

17. The method of claim 15 wherein the presentation location identified by the first presentation address and the presentation location identified by the second presentation address include no common presentation location in a common presentation region included in the presentation region including a presentable representation of the first location in the first map and the presentation region including a presentable representation of the second location in the second map.

18. The method of claim 1 wherein:
at least one of the first address space and the second address space is a geospatial address space associated with a mapped geospatial region including a mapped location represented by at least one of the first location included in the first map and the second location included in the second map; and
the at least one of the first map and the second map represent the geospatial region.

19. The method of claim 1 further comprising:
receiving an input corresponding to one of the first location and the second location;
determining a geospatial address based on the one of the first address and the second address; and
determining the network identifier based on the geospatial address.

20. A system for associating resources of a first geospace with a second geospace, the system comprising:
means for presenting a first representation of a resource at a first location in a first map associated with a first address space, wherein the first location has a first address in the first address space and an association between the first address space and a network identifier space includes an association between the first address and a network identifier for accessing the resource;
means for receiving a request to present a second representation of the resource in a second map associated with a second address space;
means for translating the first address in the first address space to a second address in the second address space based on a relationship associating the first address space with the second address space, wherein translating the first address to the second address includes establishing an association between the second address and the network identifier based on the association between the first address and the network identifier; and
means for presenting the second representation of the resource in the second map at a second location having the second address,
wherein at least one of the means includes at least one electronic hardware component.

21. A system for associating resources of a first geospace with a second geospace, the system comprising system components including:
a first map widget handler component configured to present a first representation of a resource at a first location in a first map associated with a first address space, wherein the first location has a first address in the first address space and an association between the first address space and a network identifier space includes an association between the first address and a network identifier for accessing the resource;
a presentation controller component configured to receive a request to present a second representation of the resource in a second map associated with a second address space;
a navigation space handler component configured to translate the first address in the first address space to a second address in the second address space based on a relationship associating the first address space with the second address space, wherein translating the first address to the second address includes establishing an association between the second address and the network identifier based on the association between the first address and the network identifier; and
a second map widget handler component configured to present the second representation of the resource in the second map at a second location having the second address,
wherein at least one of the system components includes at least one electronic hardware component.

22. The system of claim 21 wherein the presentation controller component is configured to receive the request in response to at least one of receiving user input, receiving a response associated with a request sent, receiving an asynchronous message, and an application generated event.

23. The system of claim 21 wherein the presentation controller component is configured to select the second map based on an attribute associated with the resource.

24. The system of claim 23 wherein the attribute is at least one of a measure of resource density in the first map, a task associated with the resource, a type of the resource, a cost associated with the resource, an owner of the resource, a security attribute of the resource, and a relationship between the resource and another resource.

25. The system of claim 21 wherein the navigation space handler component is configured to translate the first address to the second address by performing a predefined operation based on the relationship between the first address space and the second address space.

26. The system of claim 21 wherein:
the navigation space handler component is configured to translate the first address to the second address by translating a first pair of reference locations in the first map to a second pair of reference locations in the second map; and
a first ratio based on a pair of shortest distances between the first location and each of the first pair of reference locations and a second ratio based on a pair of shortest distances between the second location and each of the second pair of reference locations are not equal.

27. The system of claim 21 wherein:
the first map is associated with the first address space via a first association between the first map and a first region;
the second map is associated with the second address space via a second association between the second map and a second region;
the first address is associated with the first region via the first association; and
the second address is associated with the second region via the second association.

28. The system of claim 27 wherein the first region and the second region are each at least one of:
a presentation region associated with a presentation address space including a presentation address for identifying a presentation location in the presentation region for storing a presentable representation of a map including a map location corresponding to the presentation location;
a mapped region associated with a mapped address space including a mapped address for identifying a mapped location in the mapped region represented by the map including a map location corresponding to the mapped location; and
a map region associated with a map address space for identifying a map location in the map region.

29. The system of claim 21 wherein the first address space is a mapped address space including a first mapped address for identifying a mapped location in a mapped region represented at the first location in the first map and the second address space is a mapped address space including a second mapped address for identifying a mapped location in a mapped region represented at the second location in the second map.

30. The system of claim 29 wherein:
the first map and the second map represent a common mapped region;
the mapped location identified by the first mapped address and the mapped location identified by the second mapped address include a common mapped location in the common mapped region; and
the first address space and the second address space are different mapped address spaces associated with the common mapped region.

31. The system of claim 29 wherein the mapped location identified by the first mapped address and the mapped location identified by the second mapped address include no common mapped location in a common mapped region included in the mapped region represented at the first location in the first map and the mapped region represented at the second location in the second map.

32. The system of claim 21 wherein the first address space is a map address space including the first address for identifying the first location in the first map and the second address space is a map address space including the second address for identifying the second location in the second map.

33. The system of claim 32 wherein:
the first map and the second map include a common map region in the first map and in the second map;
the first location and the second location include a common map location in the common map region; and
the first address space and the second address space are different map address spaces associated with the common map region.

34. The system of claim 32 wherein the first location and the second location include no common map location in a common map region included in the first map region and the second map region.

35. The system of claim 21 wherein the first address space is a presentation address space including a first presentation address for identifying a presentation location in a presentation region including a presentable representation of the first location in the first map and the second address space is a presentation address space including a second presentation address for identifying a presentation location in a presentation region including a presentable representation of the second location in the second map.

36. The system of claim 35 wherein:
a presentable representation of at least a portion of the first map and a presentable representation at least a portion of the second map are stored in a common presentation region;
the presentation location identified by the first presentation address and the presentation location identified by the second presentation address include a common presentation location in the common presentation region; and
the first presentation address space and the second presentation address space are different presentation address spaces associated with the common presentation region.

37. The system of claim 35 wherein the presentation location identified by the first presentation address and the presentation location identified by the second presentation address include no common presentation location in a common presentation region included in the presentation region including a presentable representation of the first location in the first map and the presentation region including a presentable representation of the second location in the second map.

38. The system of claim 21 wherein:
at least one of the first address space and the second address space is a geospatial address space associated with a mapped geospatial region including a mapped location represented by at least one of the first location included in the first map and the second location included in the second map; and
the at least one of the first map and the second map represent the geospatial region.

39. The system of claim 21 further comprising an input subsystem and a resolver, wherein:
the input subsystem is configured to receive an input corresponding to one of the first location and the second location;
the navigation space handler component is configured to determine a geospatial address based on the one of the first address and the second address; and
the resolver is configured to determine the network identifier based on the geospatial address.

40. A computer readable medium storing a computer program, executable by a machine, for associating resources of a first geospace with a second geospace, the computer program comprising executable instructions for:
presenting a first representation of a resource at a first location in a first map associated with a first address space, wherein the first location has a first address in the first address space and an association between the first address space and a network identifier space includes an association between the first address and a network identifier for accessing the resource;
receiving a request to present a second representation of the resource in a second map associated with a second address space;
translating the first address in the first address space to a second address in the second address space based on a relationship associating the first address space with the second address space, wherein translating the first address to the second address includes establishing an association between the second address and the network identifier based on the association between the first address and the network identifier; and
presenting the second representation of the resource in the second map at a second location having the second address.
